(19) United States
(12) Patent Application Publication
(10) Pub. No.: US 2025/0305812 A1
(43) Pub. Date: Oct. 2, 2025

(54) METHODS FOR CHANNEL IDENTIFICATION USING JOINT FEATURE LIKEHOODS

(71) Applicant: Raytheon Company, Waltham, MA (US)

(72) Inventors: Joshua MIRAGLIA, Dammeron Valley, UT (US); Zachary Kent RASMUSSEN, Farmington, UT (US); Lisa MILLER, Draper, UT (US); David A. ZAUGG, Lehi, UT (US)

(73) Assignee: Raytheon Applied Signal Technology, Inc., San Jose, CA (US)

(21) Appl. No.: 18/620,590

(22) Filed: Mar. 28, 2024

(51) Int. Cl. G01B 9/02

(52) U.S. Cl. CPC G01B 9/02083; G01B 2290/25

(57) ABSTRACT

The likelihood that a region of a spectrum of a captured signal waveform defines a channel is determined. A spectrum snapshot is captured of the signal waveform for a spectrum. A plurality of regions is defined within the spectrum. Each region includes a subset of the signal waveform. A peak picking process is performed for the plurality of regions. A first plurality of peaks is identified within a subset of the signal waveform within a region. A periodic peak difference likelihood function is executed to determine a first likelihood value that the plurality of peaks within the subset includes a periodic frequency. A sub-carrier similarity function also is executed to determine a second likelihood value that the plurality of peaks is similar. The values are combined to determine a total likelihood value that is used to determine whether the region and subset of the signal waveform defines a channel.

### FIELD OF THE INVENTION

The present invention relates to the identification of channels in a spectrum using joint feature likelihoods. More specifically, the present invention relates to determining whether a region of a signal waveform defines a channel using the joint feature likelihoods.

### DESCRIPTION OF THE RELATED ART

Signal waveforms are emitted for power sources having different patterns and characteristics. For example, some signals may be from a single source yet look like they come from multiple sources. Channel identification for a signal having waveforms with multiple peaks that may be from one source or multiple sources is problematic. A need may arise that channel identification occur among a variety of waveforms that may include one source or a plurality of sources.

### SUMMARY OF THE INVENTION

A method including capturing a spectrum snapshot of a signal waveform from a spectrum to obtain a power spectral density is disclosed. The method also includes defining a plurality of regions within the spectrum. A first region of the plurality of regions includes a first subset of the signal waveform. The method also includes, for the plurality of regions, performing a peak picking process on the signal waveform. The method also includes identifying a first plurality of peaks within the first subset of the signal waveform within the first region. The method also includes executing a periodic peak difference likelihood function to determine a first likelihood value that the first plurality of peaks within the first subset includes a periodic frequency. The method also includes executing a sub-carrier similarity function to determine a second likelihood value that the first plurality of peaks is similar. The method also includes combining the first likelihood value and the second likelihood value to determine a total likelihood value. The method also includes determining whether the first region defines a channel based on the total likelihood value.

A non-transitory computer-readable medium is disclosed. The non-transitory computer-readable medium has stored thereon processor-executable instructions for performing operations including capturing a spectrum snapshot of a signal waveform for a spectrum to obtain a power spectral density. The operations also include defining a plurality of regions within the spectrum. A first region of the plurality of regions includes a first subset of the signal waveform. The operations also include, for the plurality of regions, performing a peak picking process on the signal waveform. The operations also include identifying a first plurality of peaks within the first subset of the signal waveform within the first region. The operations also include executing a periodic peak difference likelihood function to determine a first likelihood value that the first plurality of peaks includes a periodic frequency. The operations also include executing a sub-carrier similarity function to determine a second likelihood value that the first plurality of peaks is similar. The operations also include combining the first likelihood value and the second likelihood value to determine a total likelihood value. The operations also include determining whether the first region defines a channel based on the total likelihood value.

A method is disclosed. The method includes capturing a spectrum snapshot of a signal waveform for a spectrum to obtain a power spectral density. The method also includes defining a plurality of regions within the spectrum. A first region of the plurality of regions includes a first subset of the signal waveform. The method also includes, for the plurality of regions, performing a peak picking process on the signal waveform. The method also includes identifying a first plurality of peaks within the first subset of the signal waveform within the first region. The method also includes executing a periodic peak difference likelihood function to determine a first likelihood value that the first plurality of peaks includes a periodic frequency. The method also includes executing a sub-carrier similarity function to determine a second likelihood value that the first plurality of peaks is similar. The method also includes combining the first likelihood value and the second likelihood value to determine a total likelihood value. The method also includes determining the first region does not define a channel based on the total likelihood value. The method also includes shifting the first region within the spectrum having the signal waveform. The first plurality of peaks for the first region includes a second subset of the signal waveform having at least one peak different from the first subset of the signal waveform. The method also includes repeating the executing steps and the combining step to determine an update to the total likelihood value. The method also includes determining that the first region defines a channel based on the updated total likelihood value. The method also includes expanding the first region of the plurality of regions defining the channel to include an expanded subset of the signal waveform. The expanded subset includes the second subset of the signal waveform. The method also includes identifying a second plurality of peaks within the expanded subset of the signal waveform. The second plurality of peaks includes the first plurality of peaks. The method also includes executing the periodic peak difference likelihood function to determine the first likelihood value that the second plurality of peaks within the expanded subset includes the periodic frequency. The method also includes executing the sub-carrier similarity function to determine that second likelihood value that the second plurality of peaks is similar. The method also includes combining the first likelihood value and the second likelihood value to determine the total likelihood value. The method also includes determining the first region having the expanded subset of the signal waveform defines the channel based on the total likelihood value. This process continues until the region does not contain a channel. Then the region contracts to the previous point of expansion where it did contain a channel, and a channel is declared. This process then starts over again to identify additional channels within the spectrum.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps may be rearranged, combined, distributed, eliminated, or otherwise changed, while remaining with the scope of the disclosed embodiments.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 illustrates a block diagram of a system according to the disclosed embodiments.

FIG. 2 illustrates a flowchart for determining whether a channel is defined in a signal waveform according to the disclosed embodiments.

FIG. 3A illustrates another flowchart for determining whether a channel is defined in a signal waveform according to the disclosed embodiments.

FIG. 3B further illustrates the flowchart of FIG. 3A.

FIG. 4 illustrates an example of a captured spectrum snapshot having signal waveforms according to the disclosed embodiments.

### DETAILED DESCRIPTION OF THE PREFERRED EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and

B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

The disclosed embodiments may characterize the general features of a channel in such a way that peaks within a spectrum can be grouped together. Because a feature of a generalized channel is its sub-carrier periodicity, the disclosed embodiments use a periodic peak function to determine whether a region includes a periodic frequency. Aside from the periodic peaks, the disclosed embodiments define two new features to characterize a channel, a sub-carrier similarity and a channel density likelihood.

Starting with the sub-carrier similarity likelihood, the disclosed embodiments consider three measures of similarity. First, the amplitudes should be relatively constant, especially in the center of the channels. Second, the bandwidths should be the same within uncertainty. Next, the shape of the sub-carriers should be the same within considerations for noise and filter profiles. Significance of bandwidths and amplitudes differences are computed as a Z-score matrix, or a measure of how many standard deviations away a value is from the presumed model's center.

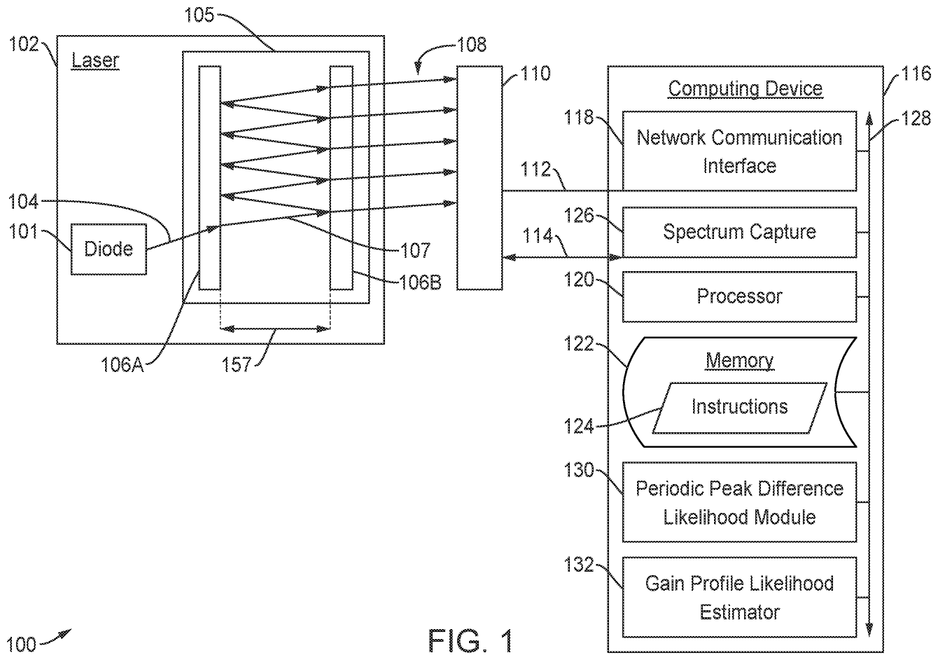

FIG. 1 depicts a system 100 having a Fabry-Perot laser 102 according to the disclosed embodiments. System 100 includes a laser 102 that emits beams 108 from a Fabry-Perot interferometer 105. Interferometer 105 may emit offset beams 108 that are detected by detector 110. Detector 110 is configured to detect radiation that has passed interferometer 105. Detector 110 may detect multiple pass bands simultaneously. In other words, detector 110 may detect or measure at least two transmission peaks simultaneously. Signals detected by detector 110 may be used for processing within computing device 116.

Laser 102 may include a laser diode 101 to emit beam 104. Beam 104 may be referred to as a signal having light transmitting at a wavelength. In some embodiments, beam 104 is a monochromatic signal found in optical fiber spectrums, such as the O-band. The light is received by interferometer 105. Interferometer 105 includes plates 106A and 106B. Beam 104 is reflected between plates 106A and 106B multiple times as shown by reflected beam 107. Plates 106A and 106B may be glass plates having a distance 157 between them. In some embodiments, plates 106A and 106B are partially silvered glass plates.

Reflected beam 107 is reflected back and forth between plates 106A and 106B. Each time reflected beam 107 reaches plate 106B, part of the light or signal is transmitted towards detector 110, resulting in offset beams 108. Offset beams 108 may interfere with each other. A large number of interfering offset beams 108 may produce an interferometer 105 with a high resolution. Thus, interferometer 105 may make use of multiple reflections that follow an interference condition.

Detector 110 receives beams 108 from laser 102. Beams 108 may include a beam 108 emitted towards a target with offset beams produced by interferometer 105. In some embodiments, a target may be placed between interferometer 105 and detector 110. Offset beams 108 may impact the target with the radiation resulting from the impact being detected by detector 110. In other embodiments, a lens may be placed between interferometer 105 and detector 110.

System 100 also includes computing device 116. Computing device 116 may obtain information for detector 110 and perform operations to determine whether the received radiation is a signal. It also may obtain signal waveforms of energy detected by detector 110. Computing device 116 make execute operations, as disclosed below. Computing device 116 may be connected to detector 110 using network communication interface 118. Connection 112 allows data to be exchanged between detector 110 and network communication interface 118. In some embodiments, connection 112 may be a wired connection. Alternatively, connection 112 may be wireless. Further, connection 112 may be made through a network accessible by computing device 116.

Computing device 116 also includes one or more processors (processor) 120 and one or more memory storages (memory) 122. Memory 122 may store instructions 124 that are executed by processor 120. Instructions 124 configures processor 120 to perform operations, as disclosed below. Instructions 124 may be updated to configure processor 120 to perform updated operations. In some embodiments, processor 120 may be configured to invoke a periodic peak difference likelihood module 130 and a gain profile likelihood estimator 132. Processor 120 may be configured to act as these components by instructions 124. Components within computing device 116 may be connected to processor 120 via bus 128.

Processor 120 also may control a spectrum capture module 126 to capture a spectrum snapshot 114 of signal waveforms detected by detector 110. Spectrum snapshot 114 may include signal waveforms for radiation received by detector 110. Spectrum capture module 126 provides spectrum snapshot 114 to processor 120. In some embodiments, processor 120 may act as spectrum capture module 126 to retrieve the data from detector 110. Periodic peak difference likelihood module 130, sub-carrier similarity module 132, and channel density likelihood module 134 may use spectrum snapshot 114 in determining likelihood values to determining existence of a channel in the captured waveform.

Periodic peak difference likelihood module 130, sub-carrier similarity module 132, and channel density likelihood module 134 may be enabled by processor 120. For example, processor 120 may execute instructions 124 to generate modules 130, 132, and 134. Alternatively, each module may be enabled by a separate processor to execute the functions disclosed below.

In other embodiments, this invention could pertain to spectra containing multiple sources, some of which might be made up of multiple subcarriers or peaks. It could pertain to either optical or RF spectra.

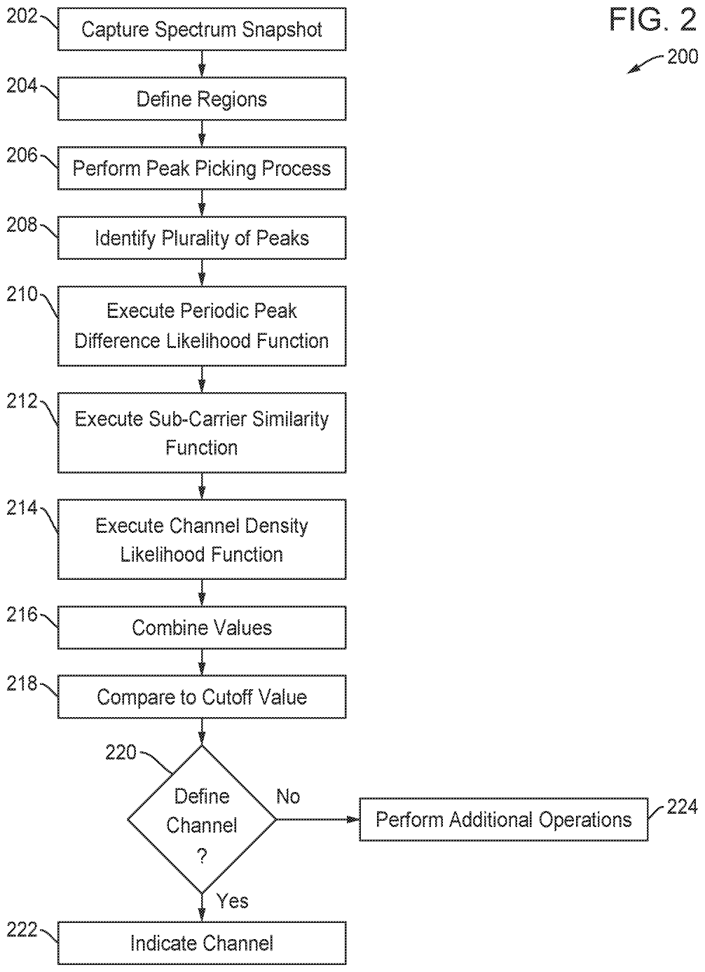

FIG. 2 depicts a flowchart 200 for determining whether a channel is defined in a signal waveform according to the disclosed embodiments. Flowchart 200 may refer to FIG. 1 for illustrative purposes. Flowchart 200, however, is not limited to the embodiments disclosed by FIG. 1. A channel may be defined as a set of adjacent peaks that comes from the same source. The number of peaks may be 1 to N. Different types of waveforms may be found within a channel that are from the single source, such as laser 102.

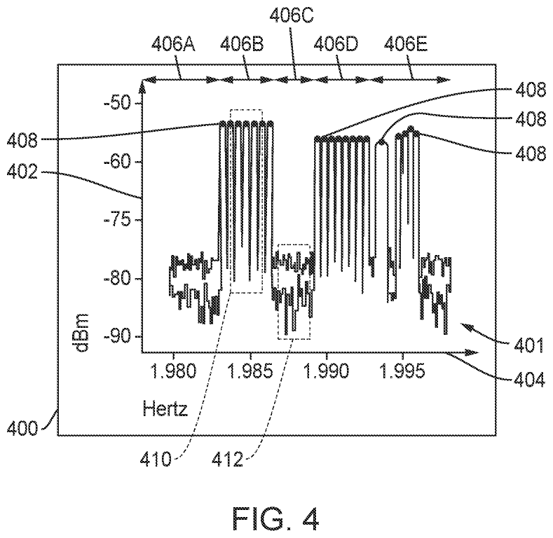

Step 202 executes by capturing a spectrum snapshot of signal waveforms to obtain a power spectral density. Examples of signal waveforms may be shown by FIG. 4. The spectrum snapshot 400 may be taken from detector 110. Step 204 executes by defining regions within the spectrum captured by the spectrum snapshot. Referring to FIG. 4, spectrum snapshot 400 having signal waveforms 401 is shown. Axis 402 and axis 404 are provided for reference in showing the signal waveforms within the spectrum captured by spectrum capture module 126. Axis 402 may show decibels-milliwatts, or dBm, used to indicate a power level for the signal waveforms. Axis 404 may show hertz, meters, or frequency, for the signal waveforms.

Regions 406A, 406B, 406C, 406D, and 406E may be defined for signal waveforms 401. Regions may be defined according to groups of signals within a frequency range. Alternatively, the frequency range encompassed by signal waveforms may be broken into additional regions separated according to average SNR.

Step 206 executes by performing a peak picking process to identify a plurality of peaks within the signal waveforms. The peak picking process may be performed according to various methods. For example, a baseline may be established such that any waveform above the baseline is considered a peak. Further, a noise floor may be established so that signals above the noise floor are considered to have peaks.

Referring to FIG. 4, signal waveform 401 is shown within spectrum snapshot 400. Signal waveform 401 includes several peaks 408. As may be appreciated, peaks 408 vary in height, or dBm. Peaks 408 may be picked according to the peak picking process. Some regions, such as regions 406A and 406C, may not have any peaks. Regions 406B, 406D, and 406E, however, may include peaks 408 selected according to the peak picking process.

Step 208 executes by identifying a plurality of peaks 408 within a region within a subset of signal waveform 401 for a region. For example, plurality of peaks 408 may be identified for subset 410 of signal waveform 401 for region 406B. Subset 410 may not include part of signal waveform 401 in regions 406A and 406C.

Step 210 executes by executing a periodic peak difference likelihood function to determine a periodic peak likelihood value. Periodic peak difference likelihood module 130 may be used in computing device 116 to perform this process. For a periodic peak likelihood value, module 130 calculates the spread of the differences between neighboring peaks about a candidate peak periodicity. The median peak difference may be a candidate for peak periodicity.

A low spread across peak differences should indicate a high likelihood that the picked peaks are periodic. For example, referring to FIG. 4, the disclosed embodiments may determine whether peaks 408 within region 406B are periodic, or include a periodic frequency. A high spread about the point may indicate a low likelihood that peaks 408 are periodic. To convert this spread metric to a likelihood, module 130 may normalize the metric and add a significance parameter based on a peak center uncertainty before passing it to a tanh function. The tanh function acts like a hyperbolic function that provides smoothness and has a range of [0,1] for positive inputs. A likelihood function should be monotonic and exhibit a soft cutoff property so functions like an inverse exponential and tanh may be used.

In some embodiments, the peak periodic likelihood function may be shown as

### Equation 1:

$$Lpd = 1 - tanh ( {( \sum M ( Δ {p}_{c , i}^{′} ) )}^{2} / ( N * δ {p}_{c}^{2} ) ) ,$$

$${L}_{pd} = 1 - tanh ( \frac{\sum {M ( Δ {p}_{c , i}^{′} )}^{2}}{N * δ {p}_{c}^{2}} ) ,$$

Δp′_{c,i}=ith peak difference,
M(x)=Difference between x and multiple of median peak delta
δp_{c}=uncertainty in peak centers
   where L_{pd} is the peak periodic likelihood value, Δp′_{c,i} is the ith peak difference, M(x) is the difference between x and a multiple of the median peak difference or delta, and δp_{c} is the uncertainty in peak centers, or the significance parameter disclosed above. The peak periodic likelihood value may reflect how likely the subset of the signal waveform is to include periodic peaks.

In some embodiments, function M(x) may be defined, which takes in a peak difference and outputs the distance to the closest integer multiple of the candidate peak periodicity. This feature allows for peaks to be missing in the spectrum capture yet also allows the disclosed embodiments to predict a periodic spectrum if the rest of the other peaks exhibit constant periodicity.

Step 212 executes by executing a sub-carrier similarity function to determine a similarity value. Sub-carrier similarity function module 132 may be used to execute this function. The sub-carrier similarity likelihood function may consider three measures of similarity. The amplitudes should be relatively constant, especially in the center of the prospective channel. Further, the bandwidths should be the same with uncertainty. Moreover, the shape of the sub-carriers should be the same within considerations for noise and filter profiles. The significance of bandwidths and amplitudes differences may be computed as a Z-score matrix. The Z-score matrix may be a measure of how many standard deviations away a value is from the presumed model's center. It may be defined as

### Equations 2 and 3:

$${Z}_{A} = {{\sum }_{i , j}}^{i \neq j} \frac{\vert {A}_{i} - {A}_{j} \vert}{\sqrt{{σ}_{A , i}^{2} + {σ}_{A , j}^{2}}} , {A}_{m} = Amplitude of the peak ,$$

$${σ}_{A , m}^{2} = noise estimate for each peak$$

$${Z}_{B} = {{\sum }_{i , j}}^{i \neq j} \frac{\vert {B}_{i} - {B}_{j} \vert}{\sqrt{{σ}_{B , i}^{2} + {σ}_{B , j}^{2}}} , {B}_{m} = Bandwidth of the peak ,$$

$${σ}_{B , m}^{2} = noise estimate for bandwidths$$

The model in this instance may be a worst-case normal distribution centered on either the average bandwidth and amplitude for bandwidth and amplitude Z-scores, respectively. The standard deviation is computed as the uncertainty given from the estimated noise of the spectrum. The Z-score matrix includes computed Z-scores for each sub-carrier in the proposed channel.

For shape similarity, the disclosed embodiments may consider the difference between subcarrier power values in a normalized range within the bandwidth edges. Due to potential filtering effects at the edges of the proposed channel, the disclosed embodiments may only compare symmetric sub-carriers. For example, in a channel of N sub-carriers, the disclosed embodiments compare sub-carriers 1 and N, 2 and (N−1), and the like. Because filtering effects should be symmetric about the center of the proposed channel, peak comparisons are done by flipping the back sub-carriers about their center. Thus, the sub-carriers may properly line up. The difference function may be defined as

### Equation 4:

$${g}_{i , j}^{′} ( x ) = {p}_{i} ( x ) - {p}_{j} ( - x ) ,$$

$${p}_{0} ( x ) = function describing peak with origin on peak center$$

To distill the comparison in peaks to a single value, the disclosed embodiments may use a least squared metric commonly used in regression to determine a goodness of fit that folds down the standard deviation of g′. The full function use may be shown as

### Equation 5:

$${Z}_{s} = \frac{1}{N} {\sum }_{i = 0}^{\text{.5} N} {( 1 + {e}^{\frac{σ ( {g}_{i , N - 1}^{′} ( x ) ) - ( δ {p}_{i} + δ {p}_{N - 1} )}{{δ}_{s}}} )}^{- 1}$$

$$δ {p}_{i} = uncertainty in peak amplitude samples$$

$${δ}_{s} = uncertainty in sampling resolution$$

For channels with expected flat peaks, shape similarity may use the same Z-score matrix approach as disclosed above for amplitude and bandwidth instead of Equation 5. This approach may be applicable for stricter instances.

Step 214 executes by executing a channel density likelihood function to determine a dense channel likelihood condition. Two methods may be used. The first method may be the ratio between the bandwidth of all peaks over the total frequency range that include these peaks. If the ratio is sufficiently high, then a dense channel condition is present as the range has a dense area dominated by sub-carriers.

A different approach also may be used to estimate the density of a channel. If the disclosed embodiments detect a dense channel, then the disclosed embodiments perform a more in-depth analysis on the peaks in that region as smoothing effects may mask sub-carrier boundaries in general peak picking. In order to make the density likelihood less dependent on the first peak picking performance, the disclosed embodiments check for sharp derivatives on the edge peaks of the proposed channel that are characteristic of dense channels when the smoothing operation is applied. The Z-score metric method may be used to create the significance metric

### Equation 6:

$$\text{?}$$

$$\text{?} \text{indicates text missing or illegible when filed}$$

If this value is sufficiently high, then the max derivatives at the edge peaks are statistically larger than the inner channel derivates, which likely means a dense channel.

Because this is a general channel classifier, the channels identified by the values may not be dense in nature. Due to the utility of performing scoped analysis on a dense channel, the disclosed embodiments may keep it as an optional feature. This feature means that if the likelihood of a channel being dense is above the individual feature likelihood cutoff, then it is incorporated into the final likelihood estimate. If it is lower than the cutoff, then no scoped analysis is performed, and the density is ignored. Other than this change, the final likelihood for being a channel is again determined by the product of all computed likelihood compared against a cutoff parameter that may be tweaked for sensitivity purposes.

It should be noted that step 214 may be an optional feature in determining whether a channel is present in a region.

Step 216 executes by combining the peak periodic likelihood value and the sub-carrier similarity value into a total likelihood value. In some embodiments, the channel density likelihood value also may be combined into the total likelihood value. The total likelihood function Lₛ that region is a channel may be defined as

### Equation 7:

$${L}_{s} = \sqrt{{\sum }_{i ∈ [ Amp , BW , Shape ]} {[ 1 + {e}^{\frac{{Z}_{μ}^{i} - C}{s}} ]}^{2}}$$

$${Z}_{μ}^{i} = mean Z score for Amplitude , BW , and Shape$$

$$C = cutoff in standard deviations$$

$$s = sensitivity$$

If the channel density likelihood value is used, then Z_{DC} also may be included in Equation 7.

Step 218 executes by comparing the total likelihood value to a cutoff value for the total likelihood value. The disclosed embodiments further determine whether a channel is present using a cutoff defined by the likelihood of each individual component being at least α. Thus, the cutoff value, or C_{off}, for a signal may be expressed as

C_{off}=α^{N}. Equation 8:

For example, if the channel determination includes two components, and the cutoff is defined by being at least 85% confident that the proposed channel exhibits each feature, then the cutoff value for the signal would be 0.85², or 0.7225. The total likelihood value, or Lₛ, is compared to the cutoff value, or C_{off}. If Lₛ is greater than C_{off}, then a channel exists for the region being analyzed.

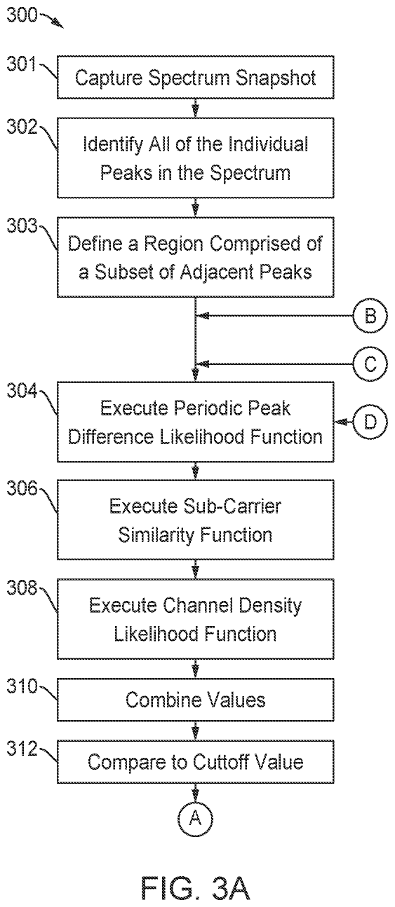

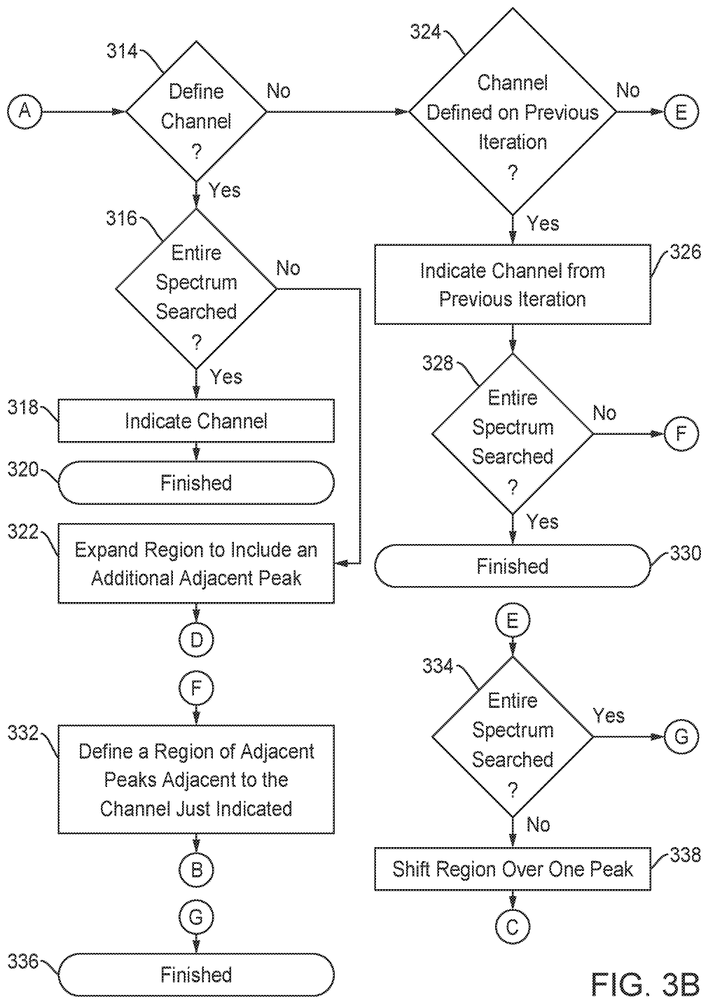

Step 220 executes by determining whether the total likelihood value exceeds the cutoff value, or passes the comparison that the region includes a channel. If yes, then step 222 executes by indicating that a channel is defined for the subset of the signal waveforms. If step 220 is no, then step 224 executes by performing additional operations. These additional operations may include shifting the region of interest and performing additional processing of peaks within the signal waveform. These features are disclosed in greater detail by FIG. 3.

For example, region 406D may be analyzed using the executed functions disclosed above. The total likelihood value exceeds the cutoff value such that region 406D defines a channel to receive a signal transmitted in system 100. Conversely, region 406E also may be analyzed using the executed functions disclosed above. The total likelihood value for the combined values may not exceed the cutoff value such that a channel is not defined by region 406E. Additional operations may be performed to define a channel within signal waveforms 401.

FIGS. 3A and 3B depict a flowchart 300 for performing spectrum channel discovery according to the disclosed embodiments. Flowchart 300 may refer to FIGS. 1, 2, and 4 for illustrative purposes. Flowchart 300, however, is not limited to the embodiments disclosed by FIGS. 1, 2, and 4.

Now that a set of peaks is identified as a channel using the above classification process, the discovery of multiple channels in a spectrum may be considered. The disclosed embodiments may use a simple sliding window process to determine if groups of peaks are channels. Multiple channels also may be found in a single spectrum capture, or spectrum snapshot 400. The process may include defining a minimum window size, such as three peaks. The groups of peaks are run through a peak channel likelihood estimator. If the likelihood of this group of peaks being a channel is low, then slide the window over an index and repeat the process. If the likelihood of the peaks being a channel is high, then expand the window until that is not the case and save the last successful run of peaks as a channel. The process is restarted using the default window size after the found channel.

Step 301 executes by capturing a spectrum snapshot of signal waveforms to obtain a power spectral density. Step 301 is similar to step 202 of flowchart 200, as disclosed above. Step 302 executes by identifying all of the individual peaks in the spectrum snapshot. Step 302 is similar to step 206 of flowchart 200, as disclosed above. Referring to FIG. 4, signal waveform 401 is shown within spectrum snapshot 402. Signal waveform 401 includes several peaks 408. As may be appreciated, peaks 408 vary in height, or dBm. Peaks 408 may be identified within signal waveform 401. Some regions, such as regions 406A and 406C, may not have any peaks. Regions 406B, 406D, and 406E, however, may include peaks 408 identified according to the peak picking process.

Step 303 executes by defining a region comprised of a subset of adjacent peaks within the peaks identified in step 302. Step 303 may be similar to step 208 of flowchart 200, as disclosed above. For example, plurality of peaks 408 may be identified for subset 410 of signal waveform 401 for region 406B. Subset 410 may not include part of signal waveform 401 in regions 406A and 406C. Region 406B may be defined for channel identification operations.

Step 304 executes by executing a periodic peak difference likelihood function to determine a periodic peak likelihood value. Step 304 is similar to step 210 of flowchart 200, as disclosed above. Step 306 executes by executing a sub-carrier similarity function to determine a similarity value. Step 306 is similar to step 212 of flowchart 200, as disclosed above. Step 308 executes by executing a channel density likelihood function to determine a dense channel likelihood condition. Step 308 is similar to step 214 of flowchart 200, as disclosed above.

Step 310 executes by combining the peak periodic likelihood value and the sub-carrier similarity value into a total likelihood value. Step 310 is similar to step 216 of flowchart 200, as disclosed above. Step 312 executes by comparing the total likelihood value to a cutoff value for the total likelihood value. Step 312 is similar to step 218 of flowchart 200, as disclosed above.

Step 314 executes by determining whether the total likelihood value exceeds the cutoff value, or passes the comparison that the region includes a channel. Step 314 is similar to step 220 of flowchart 200, as disclosed above. This step may be used to declare that a channel's combined likelihood is above the cutoff value for indicating a channel. As disclosed above, a channel may be defined as a set of adjacent peaks that come from a single source, such as laser 102. The channel may include 1 to N peaks of the signal waveform.

If step 314 is yes, then step 316 executes by determining whether the entire spectrum has been searched. Referring to FIG. 4, region 406B may be analyzed. If region 406B defines a channel according to step 314, then the disclosed embodiments determine if the entire spectrum, captured by spectrum snapshot 400, has been considered. If yes, then step 318 executes by indicating that the region indicates a channel. The channel may be reported for follow-on processing. Step 320 executes by finishing the operations.

If step 316 is no, then the entire spectrum has not been searched. Step 322 executes by expanding the region indicated as defining a channel to include an additional adjacent peak. For example, subset 410 may be expanded to include an additional adjacent peak with peaks 408. Flowchart 300 returns to step 304 to repeat the processes of determining whether subset 410 having the additional peak still defines a channel. The loops of steps may be repeated until the entire spectrum has been searched, as determined in step 316, or until a channel is not defined by subset 410 of peaks 408.

Thus, if step 314 is no, then step 324 executes by determining whether a channel was defined on a previous iteration, or by step 314. In other words, step 314 defined a channel at some point. Flowchart 300 looped back through steps 304-314 after the channel was defined and the region expanded in step 322. Now, the region does not define a channel. For example, if subset 410 within region 406B defined a channel, then a peak added from region 406D may result in a channel not being defined.

If step 324 is yes, then step 326 executes by indicating the channel from the previous iteration, or execution of step 314. For example, if subset 410 defines a channel in the previous iteration but now does not with a peak from region 406D, then the disclosed embodiments indicate subset 410 before the peak was added. Step 328 executes by determining whether the entire spectrum was searched. Step 328 may be similar to step 316, as disclosed above. If step 328 is yes, then step 330 executes by finishing operations and reporting the channel as defined.

If step 328 is no, then step 332 executes by defining a region of adjacent peaks that are adjacent to the defined channel indicated in step 326. For example, region 406B may be defined as a channel in the previous iteration. The disclosed embodiments now define a region of adjacent peaks to region 406B, such as region 406D. The newly defined region is fed back into the process disclosed by flowchart 300 at step 304 to determine whether the newly defined region indicates another channel. The disclosed embodiments may repeat steps 304-314 and 324-332 until the entire spectrum is searched and any channel applicable to the spectrum are defined.

If step 324 is no, then a channel was not defined on the previous iteration of flowchart 300. Step 334 executes by determining whether the entire spectrum has been searched. Step 334 is similar to steps 316 and 328 disclosed above. If yes, then step 336 executes by finishing operations. The captured spectrum snapshot does not appear to define a channel based on the steps executed above.

If step 334 is no, then additional processing may be performed on the spectrum. Step 338 executes by shifting the region of subset 410 by one peak. For example, subset 410 may shift towards region 406D by one peak. Subset 410 also deletes a peak in the opposite direction. The region for subset 410 is not expanded but shifted to include the new peak. Flowchart 300 then returns to step 304 to continue processing. Thus, operations are performed until the entire spectrum is searched to define possible one or more channels.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer-usable program code embodied in the medium.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

1. A method comprising:
capturing a spectrum snapshot of a signal waveform for a spectrum to obtain a power spectral density;
defining a plurality of regions within the spectrum, wherein a first region of the plurality of regions includes a first subset of the signal waveform;
for the plurality of regions, performing a peak picking process on the signal waveform;
identifying a first plurality of peaks within the first subset of the signal waveform within the first region;
executing a periodic peak difference likelihood function to determine a first likelihood value that the first plurality of peaks within the first subset includes a periodic frequency;
executing a sub-carrier similarity function to determine a second likelihood value that the first plurality of peaks is similar;
combining the first likelihood value and the second likelihood value to determine a total likelihood value; and
determining whether the first region defines a channel based on the total likelihood value.

2. The method of claim 1, further comprising executing a channel density likelihood function to determine a third likelihood value.

3. The method of claim 2, further comprising combining the third likelihood value with the first likelihood value and the second likelihood value to determine the total likelihood value.

4. The method of claim 1, further comprising comparing the total likelihood value with a cutoff value that the first region is the channel.

5. The method of claim 1, further comprising determining that the first region does not define the channel based on the total likelihood value.

6. The method of claim 5, further comprising
shifting the first region within the spectrum having the signal waveform, wherein the first plurality of peaks for the first region includes a second subset of the signal waveform having at least one peak different from the first subset of the signal waveform;
repeating the executing steps and the combining steps to determine an update to the total likelihood value; and
determining that the first region defines a channel based on the updated total likelihood value.

7. The method of claim 6, further comprising
expanding the first region of the plurality of regions defining the channel to include an expanded subset of the signal waveform, wherein the expanded subset includes the second subset of the signal waveforms for the first region; and
identifying a second plurality of peaks within the expanded subset of the signal waveform, wherein the second plurality of peaks includes the first plurality of peaks.

8. The method of claim 7, further comprising
executing the periodic peak difference likelihood function to determine the first likelihood value that the second plurality of peaks within the expanded subset includes the periodic frequency;
executing the sub-carrier similarity function to determine the second likelihood value that the second plurality of peaks is similar;
combining the first likelihood value and the second likelihood value to determine the total likelihood value; and
determining the first region having the expanded subset of the signal waveform defines the channel based on the total likelihood value.

9. The method of claim 1, wherein the executing the sub-carrier similarity function includes
determining an amplitude score for the first plurality of peaks;
determining a bandwidth score for the first plurality of peaks; and
determining a shape similarity score for the first plurality of peaks.

10. A non-transitory computer-readable medium having stored thereon processor-executable instructions for performing operations comprising:
capturing a spectrum snapshot of a signal waveform for a spectrum to obtain a power spectral density;
defining a plurality of regions within the optical fiber spectrum, wherein a first region of the plurality of regions includes a first subset of the signal waveform;
for the plurality of regions, performing a peak picking process on the signal waveform;
identifying a first plurality of peaks within the first subset of the signal waveform within the first region;
executing a periodic peak difference likelihood function to determine a first likelihood value that the first plurality of peaks within the first subset includes a periodic frequency;
executing a sub-carrier similarity function to determine a second likelihood value that the first plurality of peaks is similar;
combining the first likelihood value and the second likelihood value to determine a total likelihood value; and
determining whether the first region defines a channel based on the total likelihood value.

11. The non-transitory computer-readable medium of claim 10, further comprising instructions for performing operations including executing a channel density likelihood function to determine a third likelihood value.

12. The non-transitory computer-readable medium of claim 11, further comprising instructions for performing operations including combining the third likelihood value with the first likelihood value and the second likelihood value to determine the total likelihood value.

13. The non-transitory computer-readable medium of claim 10, further comprising instructions for performing operations including comparing the total likelihood value with a cutoff value that the first region is the channel.

14. The non-transitory computer-readable medium of claim 10, further comprising instructions for determining that the first region does not define the channel based on the total likelihood value.

15. The non-transitory computer-readable medium of claim 14, further comprising instructions for
shifting the first region within the spectrum having the signal waveform, wherein the first plurality of peaks for the first region includes a second subset of the signal waveform having at least one peak different from the first subset of the signal waveform;
repeating the executing steps and the combining steps to determine an update to the total likelihood value; and
determining that the first region defines a channel based on the updated total likelihood value.

16. The non-transitory computer-readable medium of claim 15, further comprising instructions for
expanding the first region of the plurality of regions defining the channel to include an expanded subset of the signal waveform, wherein the expanded subset includes the second subset of the signal waveforms for the first region; and
identifying a second plurality of peaks within the expanded subset of the signal waveform, wherein the second plurality of peaks includes the first plurality of peaks.

17. The non-transitory computer-readable medium of claim 16, further comprising instructions for
executing the periodic peak difference likelihood function to determine the first likelihood value that the second plurality of peaks within the expanded subset includes the periodic frequency;
executing the sub-carrier similarity function to determine the second likelihood value that the second plurality of peaks is similar;
combining the first likelihood value and the second likelihood value to determine the total likelihood value; and
determining the first region having the expanded subset of the signal waveform defines the channel based on the total likelihood value.

18. The non-transitory computer-readable medium of claim 10, wherein the executing the sub-carrier similarity function includes
determining an amplitude score for the first plurality of peaks;
determining a bandwidth score for the first plurality of peaks; and
determining a shape similarity score for the first plurality of peaks.

19. A method comprising:
capturing a spectrum snapshot of a signal waveform for a spectrum to obtain a power spectral density;
defining a plurality of regions within the spectrum, wherein a first region of the plurality of regions includes a first subset of the signal waveform;
for the plurality of regions, performing a peak picking process on the signal waveform;
identifying a first plurality of peaks within the first subset of the signal waveform within the first region;
executing a periodic peak difference likelihood function to determine a first likelihood value that the first plurality of peaks includes a periodic frequency;
executing a sub-carrier similarity function to determine a second likelihood value that the first plurality of peaks is similar;
combining the first likelihood value and the second likelihood value to determine a total likelihood value;
determining the first region does not define a channel based on the total likelihood value;
shifting the first region within the spectrum having the signal waveform, wherein the first plurality of peaks for the first region includes a second subset of the signal waveform having at least one peak different from the first subset of the signal waveform;
repeating the executing steps and the combining step to determine an update to the total likelihood value;
determining that the first region defines a channel based on the updated total likelihood value;
expanding the first region of the plurality of regions defining the channel to include an expanded subset of the signal waveform, wherein the expanded subset includes the second subset of the signal waveform;
identifying a second plurality of peaks within the expanded subset of the signal waveform, wherein the second plurality of peaks includes the first plurality of peaks;
executing the periodic peak difference likelihood function to determine the first likelihood value that the second plurality of peaks within the expanded subset includes the periodic frequency;
executing the sub-carrier similarity function to determine the second likelihood value that the second plurality of peaks is similar;
combining the first likelihood value and the second likelihood value to determine the total likelihood value; and
determining the first region having the expanded subset of the signal waveform defines the channel based on the total likelihood value.

20. The method of claim 19, further comprising repeating the expanding step until the channel is not defined based on the total likelihood value.
